(19) United States
(12) Patent Application Publication
(10) Pub. No.: US 2026/0314777 A1
(43) Pub. Date: Oct. 15, 2026

(54) Push-to-Touch Card Holder and Mobile Phone Shell with the Card Holder

(71) Applicant: Shenzhen Hongcheng Vision Technology Co., Ltd., Shenzhen (CN)

(72) Inventors: Guolin HUANG, Shenzhen (CN); Bangzao ZHANG, Shenzhen (CN)

(21) Appl. No.: 19/215,402

(22) Filed: May 22, 2025

(30) Foreign Application Priority Data
Apr. 9, 2025 (CN) 2025206519383

(51) Int. Cl. A45C 11/18; A45C 11/00

(52) U.S. Cl. CPC A45C 11/182; A45C 11/002

(57) ABSTRACT

The present invention relates to a push-to-touch card holder including a card base, a card plate for opening or closing a card cavity, and a resistance assembly mounted on the card base or the card plate, where the resistance assembly includes resistance beads and a spring having one end interfaced to the resistance beads, the card base or the card plate is provided with a plurality of fixed bead holes, the spring is used for urging the resistance beads to be embedded into the fixed bead holes, and the resistance beads are arranged in a switching manner along each fixed bead hole by a driving force. The present invention aims to improve a user’s push feeling on touch and a push feeling on hand, thereby improving a user’s operating experience of the card holder.

### TECHNICAL FIELD

The present invention relates to the technical field of card holders, and more particularly, to a push-to-touch card holder and a mobile phone shell with the card holder.

### BACKGROUND ART

With the continuous development of electronic technology, various types of cards have emerged, such as bank cards, bus cards, access cards, and shopping cards. Therefore, users often store cards in card holders, and then assemble the card holders with protective shells, by combining the card holders with electronic devices, it is convenient to carry the cards.

For example, the prior patent with authorization announcement number CN220192398U discloses a new type of card holder including a card holder housing and a pushing assembly; the pushing assembly is located inside the card holder housing, which includes an upper shell and a lower shell; the pushing assembly includes a primary gear, a secondary gear, a rack, a first pushing rod, and a second pushing rod, where the primary gear is rotatably connected to the first gear shaft, and the first gear shaft is fixedly connected to the card holder housing; the secondary gear is rotatably connected through a second gear shaft, and one end of the second gear shaft is fixedly connected to the lower housing; the rack is slidably connected to the lower housing and meshes with the primary gear and the secondary gear; the secondary gear is fixedly connected to the first pushing rod and is used to push the card laterally; the second pushing rod is fixedly connected to the lower shell and used to push the card longitudinally; a first notch which is used to insert the card into the card shell is provided at the top of the lower shell.

In the prior art, the structure of the pushing assembly is complex and costly, meanwhile, the use of gear meshing rotation is prone to cause wear and tear, which affects the service life of the pushing assembly, and the opening and closing of the card holder lacks a sense of control, resulting in a poor user experience of the card holder.

### SUMMARY OF THE INVENTION

An objective of the present invention is to provide a push-to-touch card holder, which is intended to solve the problem of poor experience in using the card holder in the prior art.

The present invention is implemented as a push-to-touch card holder including a card base, a card plate and a resistance assembly, where the card base has a card cavity for receiving a card, the card base and the card plate are arranged in a movable assembly configuration, the card plate is used for opening or closing the card cavity, the card base or the card plate can move mutually under a driving force, and the resistance assembly is mounted on the card base or the card plate; the resistance assembly includes a resistance bead and a spring having one end fixedly arranged and the other end interfaced with the resistance beads, the card base or the card plate is provided with a plurality of fixed bead holes, the spring is used for urging the resistance bead to embed the fixed bead holes, and the resistance bead can move back and forth in the plurality of fixed bead holes by a driving force, and is positioned in any one of the fixed bead holes after the driving force is eliminated.

Further, the card base includes two base plates, where the two base plates are arranged spaced apart and correspondingly; slats are formed at the two sides of the card plate, two of the slats being arranged in a movable assembly configuration with two of the base plates.

Further, the base plate is provided with the plurality of fixed bead holes, each of the fixed bead holes being arranged sequentially in the length direction of the base plate; and two of the slats are respectively provided with the resistance assemblies in the width direction, and the resistance assemblies of the two slats are arranged correspondingly.

Further, the slat is provided with the plurality of resistance assemblies in the length direction of the slat, and two ends of the slat are provided with the resistance assemblies, respectively.

Further, the base plate has an upper strip groove, a lower strip groove and a base convex strip respectively arranged in an elongated shape, the base convex strip is arranged to be convex on a side facing the card cavity, the base convex strip is located between the upper strip groove and the lower strip groove, and each of the fixed bead holes is uniformly arranged on the side of the base convex strip facing the card cavity; the slat has a plate clamping groove, the base convex strip and the plate clamping groove are embedded into each other, and the resistance assembly is mounted on the plate clamping groove.

Further, the base plate is provided with the resistance assembly; the slat is provided with the plurality of fixed bead holes, and each of the fixed bead holes is arranged sequentially in the length direction of the slat.

Further, the resistance assembly includes a base mounted on the card base or the card plate, the spring is located inside the base and has one end fixedly interfaced with the base, the resistance beads are movably mounted with the base, and the resistance beads are movably mounted with respect to the base by an external pressure or an elastic force of the spring.

Further, the push-to-touch card holder may further include an attraction member mounted on the card base or the card plate, the attraction member being adapted to magnetically engage an outer housing.

Further, the card plate includes a main plate and an inner plate, the main plate being movably assembled with the card base, the inner plate being arranged in an elongated shape, an upper end of the inner plate interfacing the inner plate in the width direction of the inner plate, a lower end of the inner plate extending away from the inner plate, the inner plate being adapted to carry the card, and the inner plate being adapted to push out the card.

Further, the card plate includes an outer plate interfacing the main plate, and the outer plate is arranged spaced apart and correspondingly with the inner plate, and the card is between the outer plate and the inner plate.

The present invention further provides a mobile phone shell including the above-mentioned push-to-touch card holder, the mobile phone shell is provided with a mounting base, the mounting base is provided with a mounting portion for receiving the card base, the mounting portion is provided with a retaining structure with respect to the card base, the mounting base is rotatably connected to a protective cover toward the card base, the protective cover is connected to one side of the card base, and the protective cover is wrapped around the card base and the card plate.

Further, the mounting base is provided with a first mounting block projecting from one side of the mounting base with respect to the card base and a second mounting block projecting from the other side of the card base, the first mounting block being provided with a torsion spring with respect to an axis of rotation of the protective cover.

Further, the mounting base is provided with an operating cavity in a pushing-out direction away from the card plate, the protective cover is located above the operating cavity, a receiving groove is provided on an outer periphery of the mounting base, the receiving groove is in communication with the operating cavity, a rotating portion is provided in the receiving groove, and a support frame is rotatably connected, and the support frame passes through the receiving groove and is connected to the operating cavity.

Further, the protective cover is provided with a packaging portion with respect to the card holder, the packaging portion being wrapped around the card base, the packaging portion being perpendicular to the rotating portion, and the packaging portion being provided with a plurality of clamping grooves with respect to the support frame array.

Further, a plurality of retaining racks which are abutted against the card base are provided with the array of side walls of the retaining structure with respect to the card base.

Compared with the prior art, for the push-to-touch card holder provided in the present invention, when in use, a user opens a card cavity by applying a pushing force to a card base or a card plate, so as to place various types of cards, and facilitate the storage and carrying of various types of cards by the user; at the same time, when the card base and the card plate move with respect to each other, the pushing force overcomes the elastic force of the spring, so that the resistance beads move along respective fixed bead holes, and through the cooperation of the resistance beads and the fixed bead holes, the resistance beads have a small moving resistance and sound during the movement, so as to improve the push feeling on touch and a push feeling on hand of the user, thereby further improving the user's operating experience feeling of the card holder.

### BRIEF DESCRIPTION OF THE DRAWINGS

FIG. 1 is a schematic perspective view of a push-to-touch card holder according to the present invention;

FIG. 2 is a schematic cross-sectional view of a first embodiment of a push-to-touch card holder according to the present invention;

FIG. 3 is an enlarged schematic view of part A in FIG. 2;

FIG. 4 is a schematic cross-sectional view of a second embodiment of a push-to-touch card holder according to the present invention;

FIG. 5 is an enlarged schematic view of part B in FIG. 2;

FIG. 6 is an enlarged partial view of a base plate of a push-to-touch card holder according to the present invention;

FIG. 7 is a right side schematic view of a card plate of a push-to-touch card holder according to the present invention;

FIG. 8 is a schematic front view of a card plate of a push-to-touch card holder according to the present invention;

FIG. 9 is a schematic view of mounting of a card holder and a mobile phone shell of a push-to-touch card holder according to the present invention;

FIG. 10 is a schematic structural view of an unfolded protective cover of a mobile phone shell according to the present invention;

FIG. 11 is a schematic structural view of a retracted protective cover of a mobile phone shell according to the present invention; and

FIG. 12 is an exploded view of a push-to-touch card holder according to the present invention.

### DETAILED DESCRIPTION OF THE INVENTION

In order that the objects, aspects and advantages of the present invention will become more apparent, a more particular description of the present invention will be rendered by reference to the embodiments thereof which are illustrated in the appended drawings. It should be understood that the particular embodiments described herein are illustrative only and are not limiting.

The implementation of the present invention will be described in detail below with reference to specific examples.

The same or similar reference numerals in the drawings of the present embodiment correspond to the same or similar parts; in the description of the present invention, it is to be understood that the terms "upper", "lower", "left", "right", and the like, if any, indicate orientations or positional relationships based on the orientation or positional relationships shown in the drawings are merely for convenience in describing the present invention and to simplify the description, and do not indicate or imply that the devices or elements referred to must have a particular orientation, constructed and operated in a particular orientation. Thus, the terms used in describing the positional relationships in the drawings are for illustrative purposes only and are not to be construed as limiting the patent, as the specific meaning of such terms will be readily understood by a person skilled in the art based on the specific circumstances.

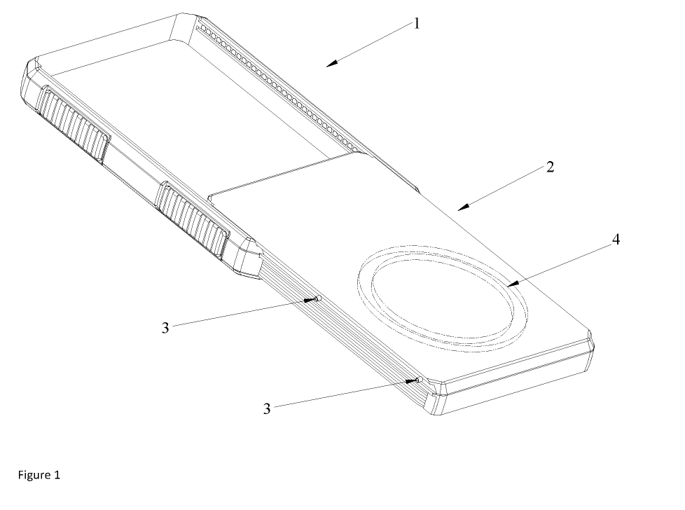

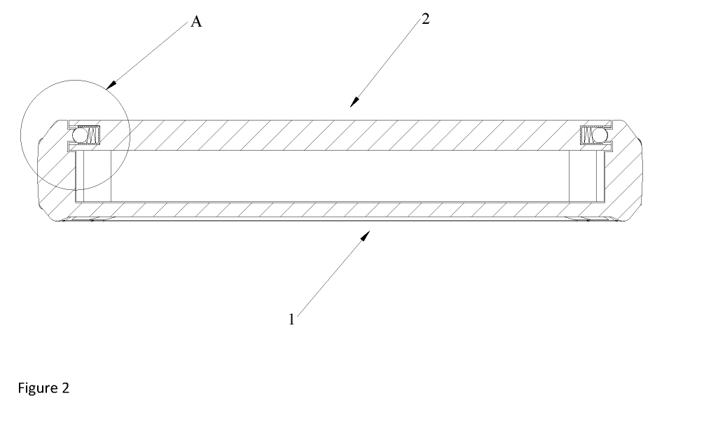

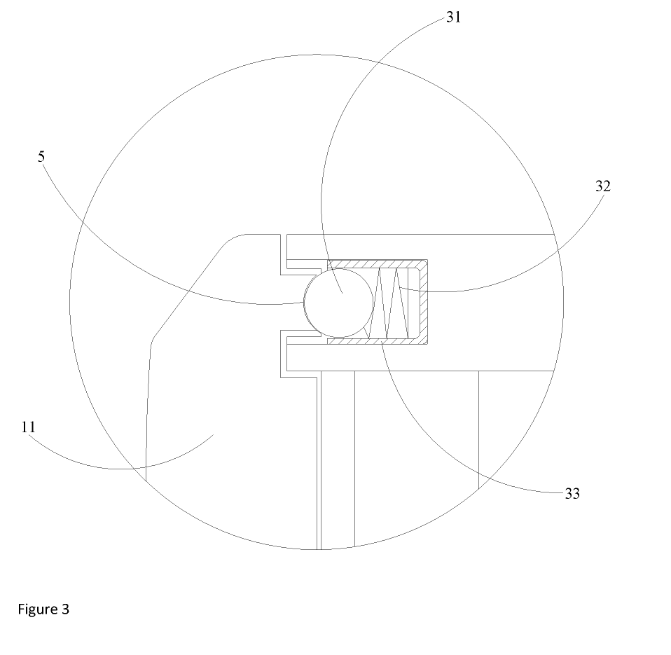

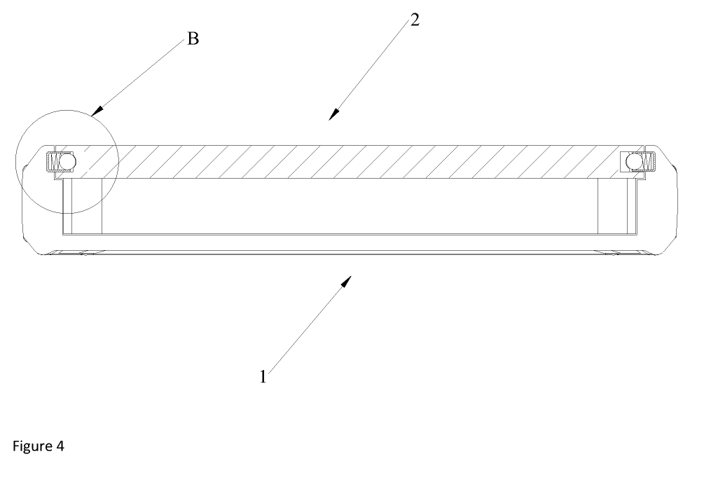

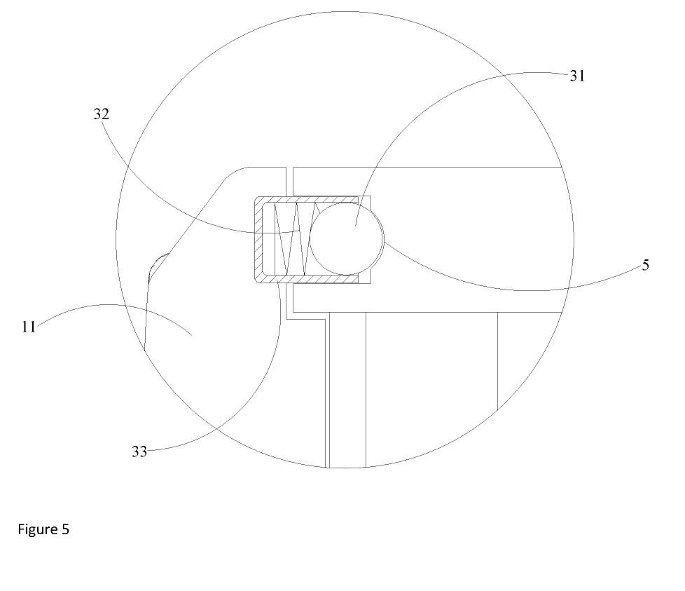

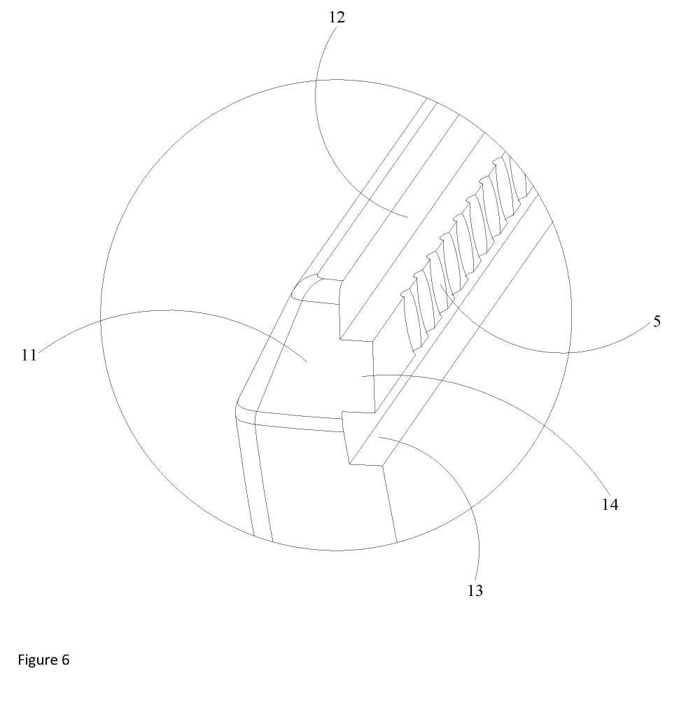

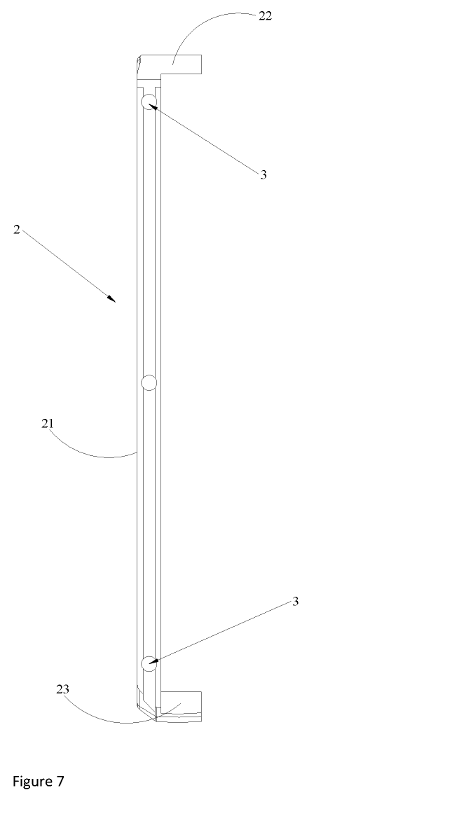

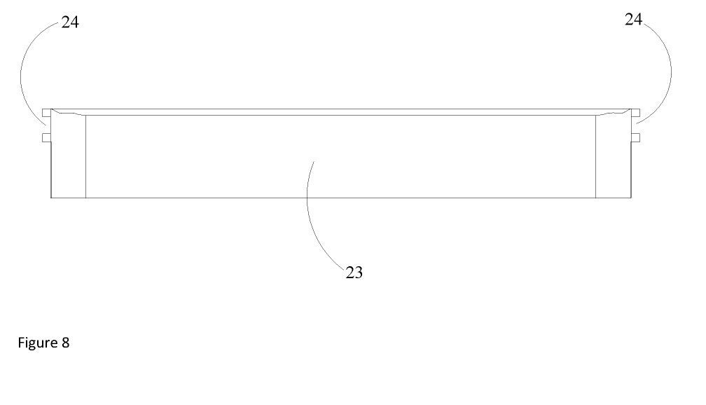

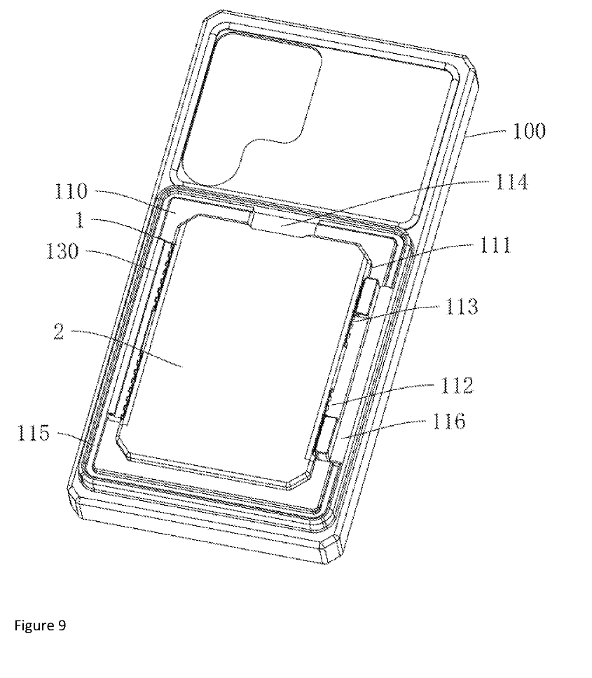

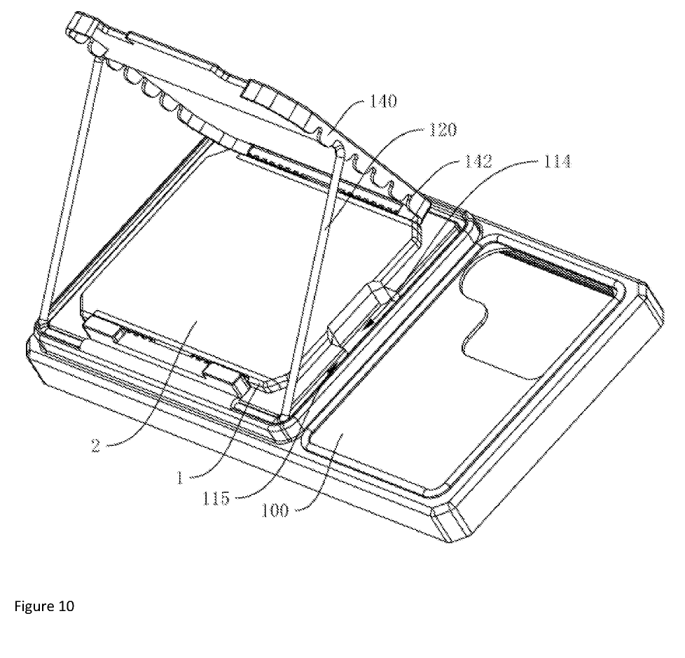

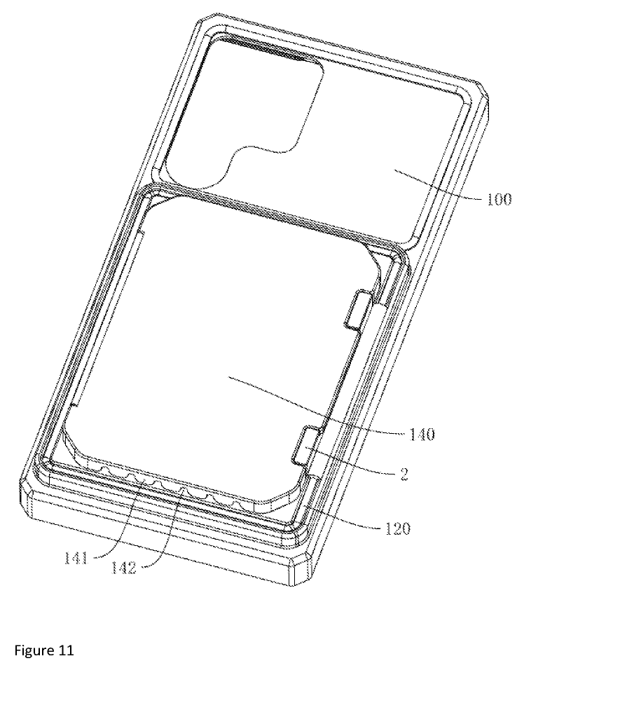

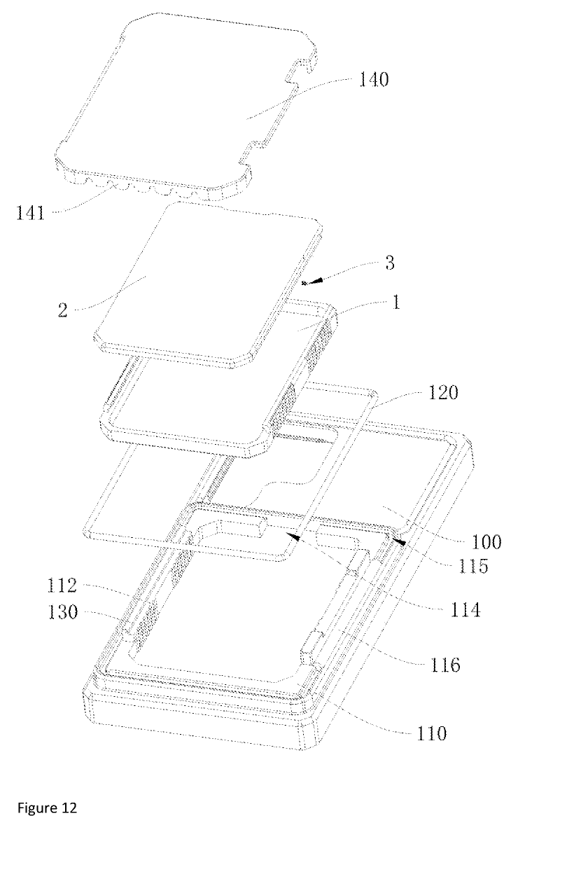

Referring to FIGS. 1-12, preferred embodiments of the present invention are shown.

A push-to-touch card holder includes a card base 1, a card plate 2 and a resistance assembly 3, where the card base 1 has a card cavity for receiving a card, the card base 1 and the card plate 2 are arranged in a movable assembly configuration, the card plate 2 is used for opening or closing the card cavity, the card base 1 or the card plate 2 can move mutually under a driving force, and the resistance assembly 3 is mounted on the card base 1 or the card plate 2; the resistance assembly 3 includes resistance beads 31 and a spring 32 having one end fixedly arranged and the other end interfaced with the resistance beads 31; a plurality of fixed bead holes 5 are provided on the card base 1 or the card plate 2; the spring 32 is used for urging the resistance beads 31 to be embedded into the fixed bead holes 5; and the resistance beads 31 can move back and forth in the plurality of fixed bead holes by a driving force, and is positioned in any one of the fixed bead holes 5 after the driving force is eliminated.

For the above-mentioned push-to-touch card holder, when in use, a user opens a card cavity by applying a pushing force to a card base 1 or a card plate 2, so as to place various types of cards, and facilitate the storage and carrying of various types of cards by the user; at the same time, when the card base 1 and the card plate 2 move with respect to each other, the pushing force overcomes the elastic force of the spring 32, so that the resistance beads 31 move along respective fixed bead holes 5, and through the cooperation of the resistance beads 31 and the fixed bead holes 5, the resistance beads 31 have a small moving resistance and sound during the movement, so as to improve the push feeling on touch and a push feeling on hand of the user, thereby further improving the user's operating experience feeling of the card holder.

The resistance assembly 3 includes a base mounted on the card base 1 or the card plate 2, the spring 32 is located inside the base and has one end fixedly interfaced with the base, the resistance beads 31 are movably mounted with the base, and the resistance beads 31 are movably mounted with respect to the base by an external pressure or the elastic force of the spring 32.

The provision of the spring element 32 and the resistance beads 31 are achieved under the action of the base, so that the service life of the resistance assembly 3 is increased.

The push-to-touch card holder further includes an attraction member 4, where the attraction member 4 is mounted on the card base 1 or the card plate 2, and the attraction member 4 is adapted to magnetically engage an outer housing; in this way, under the action of the attraction member 4, the adaptation of the card holder to the protective shell is achieved, and the combination of the card holder with the electronic device is achieved, so as to facilitate the carrying of the card.

The card plate 2 includes a main plate 21 and an inner plate 22, the main plate 21 being movably assembled with the card base 1, the inner plate 22 being arranged in an elongated shape, an upper end of the inner plate 22 interfacing with the inner plate 22 in the width direction of the inner plate 22, a lower end of the inner plate 22 extending away from the inner plate 22, the inner plate 22 being adapted to carry the card, and the inner plate 22 being adapted to push out the card.

In this way, when a card needs to be taken out, a pushing-out force is applied to the main plate 21 which moves with respect to the card base 1, the movement of the main plate 21 drives the inner plate 22 to move, and the inner plate 22 pushes out the card synchronously during the movement, so as to facilitate taking out the card.

The card plate 2 includes an outer plate 23 which interfacs with the main plate 21, and the outer plate 23 and the inner plate 22 are arranged spaced apart and correspondingly, and a card is located between the outer plate 23 and the inner plate 22; thus, by the cooperation of the outer plate 23 and the inner plate 22, the stability of the placement of each card is improved, and the card is prevented from falling out when the card is taken out.

### Embodiment 1

The card base 1 includes two base plates 11, and the two base plates 11 are arranged spaced apart and correspondingly; slats are formed at the two sides of the card plate 2, two of the slats being arranged in a movable assembly configuration with two of the base plates 11.

The base plate 11 is provided with a plurality of fixed bead holes 5, each of the fixed bead holes 5 being arranged in sequence in the length direction of the base plate 11; and two of the slats are respectively provided with the resistance assembly 3 in the width direction, and the resistance assemblies 3 of the two slats are arranged correspondingly.

In this way, the card plate 2 is applied a pushing force to move with respect to the card base 1, so as to open the card cavity; under the action of the resistance assembly 3, the user's push feeling on hand is effectively improved, the user's operating experience feeling on the card holder is improved, and at the same time, the force on the two ends is more uniform, so that the movement of the card plate 2 is more stable.

In the length direction of the slat, the slat is provided with a plurality of resistance assemblies 3, and two ends of the slat are respectively provided with the resistance assemblies 3; under the action of each resistance assembly 3, the longitudinal direction of the card plate 2 is subjected to a guiding force, facilitating the movement of the card plate 2 with respect to the card base 1, and also helping to improve the smooth movement of the card plate 2.

The base plate 11 has an upper strip groove 12, a lower strip groove 13 and a base convex strip 14 respectively arranged in an elongated shape, the base convex strip 14 is arranged to be convex on a side facing the card cavity, the base convex strip 14 is located between the upper strip groove 12 and the lower strip groove 13, and each of the fixed bead holes 5 is uniformly arranged on the side of the base convex strip 14 facing the card cavity; the slat has a plate clamping groove 24, and the base convex strip 14 and the plate clamping groove 24 can be engaged with each other, so that the resistance assembly 3 is mounted on the plate clamping groove 24.

In this way, under the cooperation action of the upper strip groove 12 and the lower strip groove 13, a guiding and limiting function is exerted on the strip portion to ensure that the card plate 2 moves linearly, facilitating the movement of the card plate 2 with respect to the card base 1, and also improving the service life of the card holder; at the same time, the alignment of the resistance beads 31 with the fixed bead holes 5 is ensured, and the normal movement of the resistance beads 31 is ensured.

### Embodiment 2

The card base 1 includes two base plates 11, where the two base plates 11 are arranged spaced apart and correspondingly, and the base plate 11 is provided with a resistance assembly 3; the slat is provided with a plurality of fixed bead holes 5, and each of the fixed bead holes 5 is arranged sequentially in the length direction of the slat.

In this way, it is used for applying a pushing force to the card plate 2, causing each of the fixed bead holes 5 of the card plate 2 to move with respect to the resistance assembly 3 of the card base 1, so as to open the card cavity; under the action of the resistance assembly 3, the user's push feeling on hand is effectively improved, the user's operating experience feeling on the card holder is improved, and at the same time, the force on the two ends is more uniform, so that the movement of the card plate 2 is more stable.

The present invention further provides a mobile phone shell 100 with the above-mentioned push-to-touch card holder, and the specific structure of the push-to-touch card holder is described with reference to the above-mentioned embodiments. Since the present mobile phone shell 100 adopts all the technical solutions of all the above-mentioned embodiments, it has at least all the advantageous effects brought about by the technical solutions of the above-mentioned embodiments, which will not be described in detail herein.

A mounting base 110 is provided on the mobile phone shell 100, the mounting base 110 is provided with a mounting portion 111 for accommodating the card base 1, the mounting portion 111 is provided with a retaining structure 112 with respect to the card base 1, the mounting base 110 is rotatably connected to the card base 1 with a protective cover 140, the protective cover 140 is connected to one side of the card base 1, and the protective cover 140 is wrapped around the card base 1 and the card plate 2.

In order to facilitate the mounting of the card holder and make the card holder itself easy to carry, the mobile phone shell 100 for containing and protecting the card holder can be specially designed for the card holder, and receiving the card holder with the mobile phone shell 100 can save space and make the card easy to carry, and can also further improve the protection performance of the card holder. In order to achieve the above-mentioned objective, the mobile phone shell 100 is provided with a mounting base 110, and the mounting portion 111 can achieve the rapid storage of the card holder by opening a groove structure sufficient to accommodate the card holder on the mounting base 110, and the groove structure can also be referred to as the mounting portion 111 which can be provided with a retaining structure 112, so that the card holder can be easily mounted into the mounting portion 111, and in this structure, the mounting base 110 can completely receive the card holder, so that the card holder can be protected by the mounting base 110; a protective cover 140 is rotatably connected to the mounting base 110; the protective cover 140 is located at one side of the card base 1; the protective cover 140 turns towards the card holder and can completely cover the card holder; and the material of the protective cover 140 can be a metal material for preventing the card in the card holder groove from being mistakenly swiped by external equipment when the card is not taken out, or an end of the protective cover 140 facing the card slot may be provided with a protective material to improve the protective effect of the card.

The mounting base 110 is provided with a first mounting block 130 projecting from one side of the mounting base 1 with respect to the card base and a second mounting block projecting from the other side of the card base, the first mounting block 130 being provided with a torsion spring with respect to an axis of rotation of the protective cover 140.

The mounting base 110 is respectively provided with a first mounting block 130 and a second mounting block on two sides of the card holder, the card base 1 is connected to the inner sides of the two mounting bases, the two mounting bases are mainly used for mounting the protective cover 140 for preventing the protective cover 140 from falling off, a torsion spring is provided on the first mounting block 130, the protective cover 140 is mounted on the torsion spring, and by means of the torsion spring, the protective cover 140 can be covered on the card plate 2 when there is no external force intervening, and this structure is easy to disassemble itself and has a good protective performance.

The mounting base 110 is provided with an operating cavity 114 in a pushing-out direction away from the card plate 2, the protective cover 140 is located above the operating cavity 114, a receiving groove 115 is provided on an outer periphery of the mounting base 110, the receiving groove 115 is in communication with the operating cavity 114, a rotating portion 116 is provided in the receiving groove 115, and a support frame 120 is rotatably connected, and the support frame 120 passes through the receiving groove 115 and is connected to the operating cavity 114.

The mounting base 110 is provided with an operating cavity 114 away from the pushing-out direction of the card plate 2; when there is no external force, the protective cover 140 covers the card plate 2, and the side edge of the protective cover 140 passes through the operating cavity 114, so that the operating cavity 114 is in a closed state; when the protective cover 140 is opened, the operating cavity 114 will be exposed; a user can easily remove or mount the card holder through the operating cavity 114; likewise, the card can be easily taken out and the card plate 2 and the card base 1 are separated; and the protective effect on the card holder can be effectively improved by the above-mentioned structure, which enables the user to quickly and stably open the card holder and remove the card when it is necessary to use the card in the card holder, which can effectively improve the user's use experience.

The protective cover 140 is provided with a packaging portion 141 with respect to the card base 1, the packaging portion 141 is wrapped around the card base 1, the packaging portion 141 is perpendicular to the rotating portion 116, and the packaging portion 141 is provided with a plurality of clamping grooves 142 with respect to the support frame 120 in an array.

The protective cover 140 is provided with a packaging portion 141 with respect to the card base 1; when the protective cover 140 covers the card holder, the packaging portion 141 will wrap around the card base 1, so that the card base 1 itself can be effectively avoided from being damaged, and the protective performance of the protective cover 140 can be improved; and a plurality of clamping grooves 142 can be provided on the packaging portion 141 towards the support frame 120, and when the protective cover 140 and the support frame 120 are unfolded, the support frame 120 can be clamped with the clamping grooves 142, so that the support frame 120 and the protective cover 140 together constitute a mobile phone support. In addition, the mobile phone holder can be adjusted by different positions of the clamping groove 142 so as to be in different positions, and the supporting angle can be adjusted so as to improve the user's experience.

A plurality of retaining racks 113 which are abutted against the card base 1 are provided with the array of side walls of the retaining structure 112 with respect to the card base 1.

The retaining structure 112 is provided with a plurality of retaining racks 113, and the card holder can be mounted more stably by using the retaining racks 113 to fit with the side wall of the card base 1; the side wall of the card base 1 can be a rack structure, and an anti-skid structure made of rubber, tracks, etc. can also be used; when the side wall of the card base 1 is a rack structure, two different racks can be arranged alternately, so that the two different racks can be clamped between two adjacent opposite types of racks; or the retaining racks 113 are very directly in a interference fit with the side wall of the card base 1, and by using this structure, the card holder can be stably clamped. Further, the overall thickness of the retaining structure 112 and the locking structure can be reduced, which is advantageous to the design of the structure, and the production cost can be reduced.

The above is merely a preferred embodiment of the present invention and is not intended to limit the scope of the present invention. Any modifications, equivalent replacements, or improvements made within the spirit and principles of the present invention shall be included within the protection scope of the present invention.

1. A push-to-touch card holder, comprising a card base, a card plate and a resistance assembly, wherein the card base has a card cavity for receiving a card, the card base and the card plate are arranged in a movable assembly configuration, the card plate is used for opening or closing the card cavity, the card base or the card plate can move mutually under a driving force, and the resistance assembly is mounted on the card base or the card plate; the resistance assembly comprises resistance beads and a spring having one end fixedly arranged and the other end interfaced with the resistance beads, the card base or the card plate is provided with a plurality of fixed bead holes, the spring is used for urging the resistance beads to be embedded into the fixed bead holes, and the resistance beads can move back and forth in the plurality of fixed bead holes by a driving force, and is positioned in any one of the fixed bead holes after the driving force is eliminated.

2. The push-to-touch card holder according to claim 1, wherein the card base comprises two base plates, wherein the two base plates are arranged spaced apart and correspondingly; slats are formed at the two sides of the card plate, two of the slats being arranged in a movable assembly configuration with two of the base plates.

3. The push-to-touch card holder according to claim 2, wherein the base plate is provided with the plurality of fixed bead holes, each of the fixed bead holes being arranged sequentially in the length direction of the base plate; and two of the slats are respectively provided with the resistance assemblies in the width direction, and the resistance assemblies of the two slats are arranged correspondingly.

4. The push-to-touch card holder according to claim 2, wherein the slat is provided with the plurality of resistance assemblies in the length direction of the slat, and two ends of the slat are provided with the resistance assemblies, respectively.

5. The push-to-touch card holder according to claim 2, wherein the base plate has an upper strip groove, a lower strip groove and a base convex strip respectively arranged in an elongated shape, the base convex strip is arranged to be convex on a side facing the card cavity, the base convex strip is located between the upper strip groove and the lower strip groove, and each of the fixed bead holes is uniformly arranged on the side of the base convex strip facing the card cavity; the slat has a plate clamping groove, the base convex strip and the plate clamping groove are embedded into each other, and the resistance assembly is mounted on the plate clamping groove.

6. The push-to-touch card holder according to claim 2, wherein the base plate is provided with the resistance assembly; the slat is provided with the plurality of fixed bead holes, and each of the fixed bead holes is arranged sequentially in the length direction of the slat.

7. The push-to-touch card holder according to claim 1, wherein the resistance assembly comprises a base mounted on the card base or the card plate, the spring is located inside the base and has one end fixedly interfaced with the base, the resistance beads are movably mounted with the base, and the resistance beads are movably mounted with respect to the base by an external pressure or an elastic force of the spring.

8. The push-to-touch card holder according to claim 1, further comprising an attraction member mounted on the card base or the card plate, the attraction member being adapted to magnetically engage an outer housing.

9. The push-to-touch card holder according to claim 1, wherein the card plate comprises a main plate and an inner plate, the main plate being movably assembled with the card base, the inner plate being arranged in an elongated shape, an upper end of the inner plate interfacing the inner plate in the width direction of the inner plate, a lower end of the inner plate extending away from the inner plate, the inner plate being adapted to carry the card, and the inner plate being adapted to push out the card.

10. The push-to-touch card holder according to claim 9, wherein the card plate comprises an outer plate interfacing the main plate, and the outer plate is arranged spaced apart and correspondingly with the inner plate, and the card is between the outer plate and the inner plate.

11. A mobile phone shell, wherein the mobile phone shell has the push-to-touch card holder according to claim 1, the mobile phone shell is provided with a mounting base, the mounting base is provided with a mounting portion for receiving the card base, the mounting portion is provided with a retaining structure with respect to the card base, the mounting base is rotatably connected to a protective cover toward the card base, the protective cover is connected to one side of the card base, and the protective cover is wrapped around the card base and the card plate.

12. The mobile phone shell according to claim 11, wherein the mounting base is provided with a first mounting block projecting from one side of the mounting base with respect to the card base and a second mounting block projecting from the other side of the card base, the first mounting block being provided with a torsion spring with respect to an axis of rotation of the protective cover.

13. The mobile phone shell according to claim 11, wherein the mounting base is provided with an operating cavity in a pushing-out direction away from the card plate, the protective cover is located above the operating cavity, a receiving groove is provided on an outer periphery of the mounting base, the receiving groove is in communication with the operating cavity, a rotating portion is provided in the receiving groove, and a support frame is rotatably connected, and the support frame passes through the receiving groove and is connected to the operating cavity.

14. The mobile phone shell according to claim 13, wherein the protective cover is provided with a packaging portion with respect to the card holder, the packaging portion being wrapped around the card base, the packaging portion being perpendicular to the rotating portion, and the packaging portion being provided with a plurality of clamping grooves with respect to the support frame array.

15. The mobile phone shell according to claim 11, wherein a plurality of retaining racks which are abutted against the card base are provided with the array of side walls of the retaining structure with respect to the card base.
